(19) United States
(12) Patent Application Publication
(10) Pub. No.: US 2026/0131653 A1
(43) Pub. Date: May 14, 2026

(54) VEHICLE DISPLAY DEVICE, CONTROL METHOD FOR VEHICLE DISPLAY DEVICE, AND RECORDING MEDIUM

(71) Applicant: HONDA MOTOR CO., LTD., Tokyo (JP)

(72) Inventors: Tsuyoshi Nojiri, Wako-shi (JP); Tatsuya Iwasa, Wako-shi (JP); Toshihiro Hashimoto, Wako-shi (JP); Haruko Okuyama, Wako-shi (JP); Yuichiro Shimura, Wako-shi (JP)

(21) Appl. No.: 19/356,483

(22) Filed: Oct. 13, 2025

(30) Foreign Application Priority Data
Nov. 11, 2024 (JP) 2024-196392

(51) Int. Cl. B60K 35/28; B60K 35/23; B60K 35/65; B60K 35/81; B60W 50/14; B60W 60/00; G09G 3/00

(52) U.S. Cl. CPC B60K 35/285; B60K 35/23; B60K 35/654; B60K 35/81; B60W 50/14; B60W 60/0051; G09G 3/001; B60K 2360/175; B60K 2360/178; B60W 2050/146; B60W 2540/225; B60W 2554/4029; G09G 2354/00; G09G 2380/10

(57) ABSTRACT

A vehicle display device includes a detection unit that detects a risk index that is present in front of a vehicle and has a possibility of coming into contact with the vehicle, and a display control unit that displays an image on a windshield of the vehicle. The display control unit momentarily displays a visibility-reducing image on the windshield in a range other than a risk index range corresponding to the risk index detected by the detection unit, the visibility-reducing image reducing visibility for a driver of the vehicle.

### INCORPORATION BY REFERENCE

The present application claims priority under 35 U.S.C. § 119 to Japanese Patent Application No. 2024-196392 filed on Nov. 11, 2024. The content of the application is incorporated herein by reference in its entirety.

### BACKGROUND OF THE INVENTION

### Field of the Invention

The present invention relates to a vehicle display device, a control method for a vehicle display device, and a recording medium.

### Description of the Related Art

Conventionally, there have been known techniques that enable a driver of a vehicle to recognize a risk index, which is an index having a possibility of coming into contact with the vehicle.

For example, Japanese Patent Laid-Open No. 2018-016117 discloses a technique in which an image is displayed on a front windshield to restrict a view for saliency parts that the driver does not need to see, thereby preventing the driver's gaze from being unnecessarily guided to objects other than a visual object that should be focused on.

For example, Japanese Patent Laid-Open No. 2020-128172 discloses a technique for displaying an image on a windshield. The technique disclosed in Japanese Patent Laid-Open No. 2020-128172 restricts the display of lane line information when the lane line information displayed on the windshield is displayed overlapping an obstacle, and thereby improves the visibility of the obstacle.

Japanese Patent Laid-Open No. 2018-016117 and Japanese Patent Laid-Open No. 2020-128172 are techniques that increase possibility that the driver of the vehicle successfully recognizes the risk index. However, in Japanese Patent Laid-Open No. 2018-016117, while saliency that the driver does not need to see is being extracted from the captured image by the camera, an image that restricts the view is displayed on the front windshield, and the driver may feel annoyed by the image being displayed. In addition, in Japanese Patent Laid-Open No. 2020-128172, while information about the lane lines of the road in front of the vehicle is being acquired, the lane line information is displayed on the windshield, and the driver may feel annoyed by the image being displayed.

Therefore, an object of the present invention is to increase a possibility that a driver of a vehicle successfully recognizes a risk index while preventing annoyance of an image being displayed on a windshield. This ultimately further improve traffic safety to contribute to development of a sustainable transport system.

### SUMMARY OF THE INVENTION

An aspect of the present invention is a vehicle display device including: a detection unit that detects a risk index that is present in front of a vehicle and has a possibility of coming into contact with the vehicle; and a display control unit that displays an image on a windshield of the vehicle, wherein the display control unit momentarily displays a visibility-reducing image on the windshield in a range other than a risk index range corresponding to the risk index detected by the detection unit, the visibility-reducing image reducing visibility for a driver of the vehicle.

According to an aspect of the present invention, it is possible to increase the possibility that the driver of the vehicle successfully recognizes a risk index while preventing annoyance of the image being displayed on the windshield.

### BRIEF DESCRIPTION OF THE DRAWINGS

FIG. 1 is a diagram showing a configuration of a vehicle;

FIG. 2 is a diagram showing a configuration in a passenger compartment of the vehicle;

FIG. 3 is a diagram showing a configuration of a vehicle display device;

FIG. 4 is a diagram for describing a calculation of a viewpoint-to-index distance;

FIG. 5 is a diagram for describing processing of a display control unit;

FIG. 6 is a diagram showing an example of a visibility-reducing image; and

FIG. 7 is a flowchart showing operation of the vehicle display device.

### DETAILED DESCRIPTION OF THE INVENTION

A first embodiment will be described below with reference to the drawings.

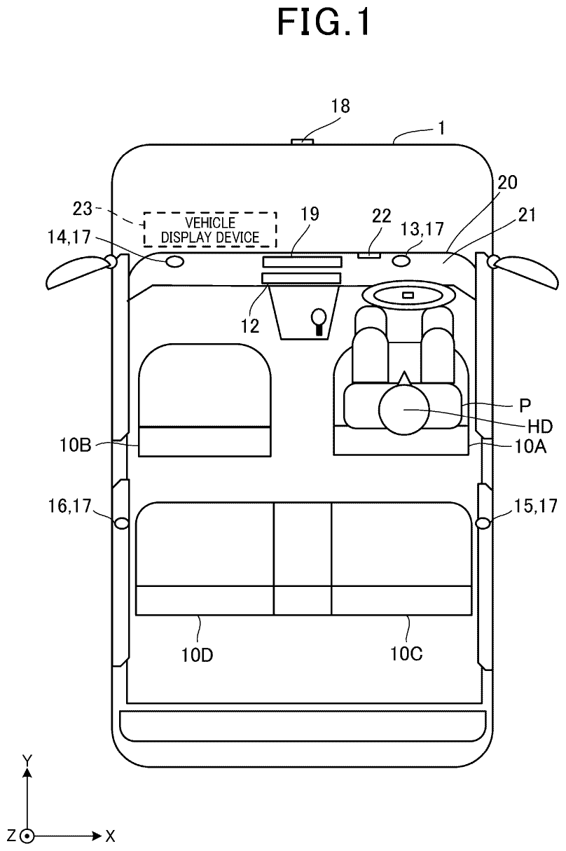

In each of FIGS. 1, 2, 4, 5, and 6, an X-axis, a Y-axis, and a Z-axis are illustrated. The X-axis, Y-axis, and Z-axis are perpendicular to each other. The Z axis indicates the up-down direction. The X-axis and Y-axis are parallel to the horizontal direction when a vehicle 1 is running. The X-axis indicates the left-right direction as the vehicle width direction. The Y axis indicates the front-rear direction. The positive direction of the X-axis indicates the right direction. The positive direction of the Y-axis indicates the forward direction. The positive direction of the Z-axis indicates the upward direction.

### 1. Configuration of Vehicle

FIG. 1 is a diagram showing a configuration of the vehicle 1.

The vehicle 1 illustrated in FIG. 1 is a four-wheeled vehicle. The vehicle 1 has a driver's seat 10A, a passenger seat 10B, a rear right seat 10C, and a rear left seat 10D. In the vehicle 1 of FIG. 1, a situation is shown in which the driver P is sitting in the driver's seat 10A.

The vehicle 1 is equipped with a touch panel 12. The touch panel 12 is composed of a display panel that displays characters and images and a touch sensor that detects contact with the display panel, which are superimposed or integrated.

The vehicle 1 is equipped with speakers 13, 14, 15, and 16. The speaker 13 outputs sound to the driver P sitting in the driver's seat 10A. The speaker 14 outputs sound to the occupant sitting in the passenger seat 10B. The speaker 15 outputs sound to an occupant sitting in the rear right seat 10C. The speaker 16 outputs sound to an occupant sitting in the rear left seat 10D. Note that the installation positions of the speakers 13, 14, 15, and 16 are not limited to those shown in FIG. 1, and may be any positions that allow sound to be output to occupants sitting in the corresponding seats.

Hereinafter, when the speakers 13, 14, 15, and 16, are not distinguished from one another, they will be expressed “speakers 17” with the reference numeral “17”.

Each speaker 17 is an example of a “stimulus output device”. The sound output by the speaker 17 is an example of a “stimulus”.

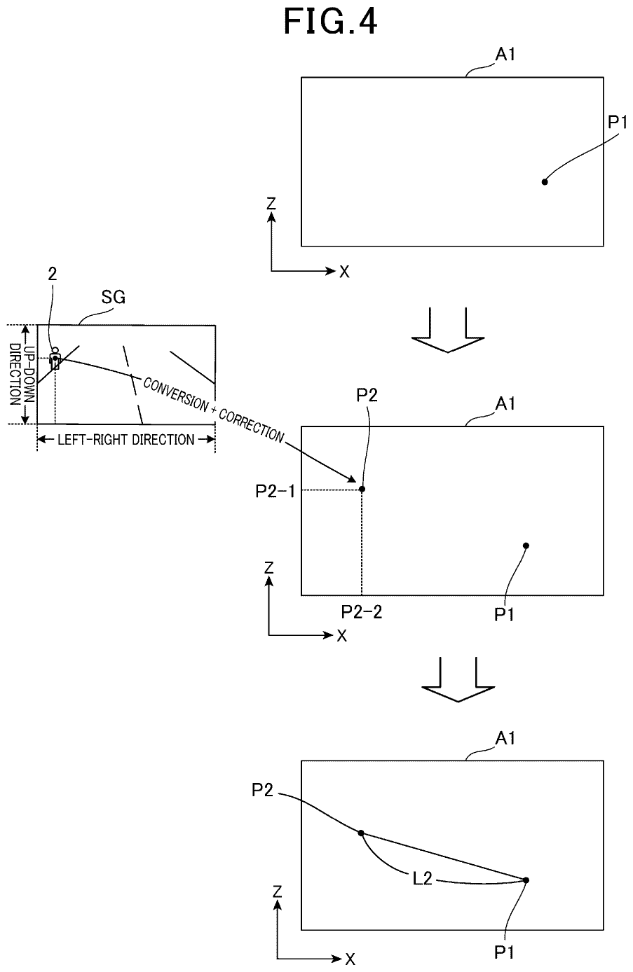

The vehicle 1 is equipped with a front camera 18 that captures images in front of the vehicle 1. The front camera 18 is provided at the front of the vehicle 1 and captures images in front of the vehicle 1. The front camera 18 captures images at a predetermined cycle when the ignition of the vehicle 1 is on, when the accessory power supply of the vehicle 1 is on, or the like. The front camera 18 outputs image data of the captured image SG (see FIG. 4, for example) obtained by capturing an image to the vehicle display device 23 each time the front camera 18 captures an image.

The vehicle 1 is equipped with a HUD (Head Up Display) 19. The HUD 19 displays an image on the windshield 20 by projecting light onto the windshield 20. As a result, the HUD 19 displays the image on the windshield 20, allowing the driver P sitting in the driver's seat to view the displayed image together with the scene in front of the vehicle 1.

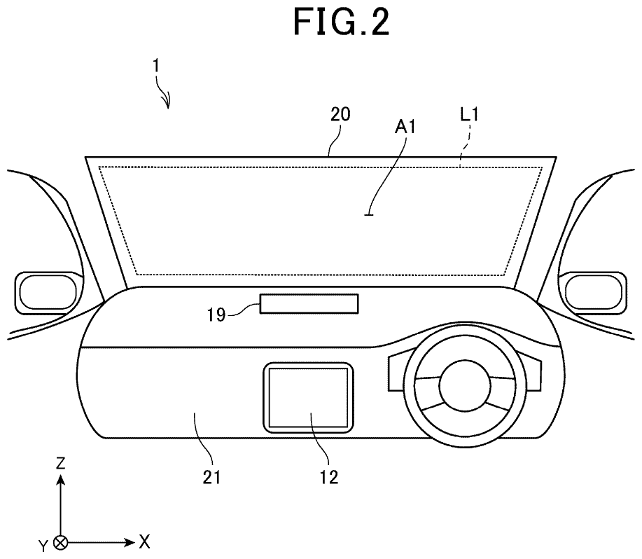

FIG. 2 is a diagram showing a configuration in the passenger compartment of the vehicle 1.

In the passenger compartment of the vehicle 1 shown in FIG. 2, there is provided an instrument panel 21 provided with a HUD 19. The instrument panel 21 is provided with a steering wheel for operating the vehicle 1, a touch panel 12, and a speaker 13.

In FIG. 2, the displayable area A1 in which the HUD 19 can display an image is illustrated as an area enclosed by a dotted line L1. The size of the displayable area A1 corresponds to the size of the magnifying mirror (concave mirror) equipped in the HUD 19. Note that the size of the displayable area A1 relative to the windshield 20 is not limited to the size shown in FIG. 2. In addition, in FIG. 2, the shape in which the longitudinal direction of the displayable area A1 is the vehicle width direction is illustrated as an example, but the shape of the displayable area A1 is not limited to the shape shown in FIG. 2.

Returning to the description of FIG. 1, the vehicle 1 is equipped with a driver monitoring camera 22. The driver monitoring camera 22 is a camera that is provided at a predetermined position in the passenger compartment of the vehicle 1 and captures an image of the driver P sitting in the driver's seat 10A. The range of image capturing with the driver monitoring camera 22 is a range that includes at least the head HD of the driver P sitting in the driver's seat 10A. The driver monitoring camera 22 captures images at a predetermined cycle when the ignition of the vehicle 1 is on, when the accessory power supply of the vehicle 1 is on, or the like. The driver monitoring camera 22 outputs image data of the captured image obtained by capturing an image to the vehicle display device 23 each time the driver monitoring camera 22 captures an image.

The vehicle 1 is equipped with a vehicle display device 23. The vehicle display device 23 is a device that displays an image on the windshield 20 with the HUD 19.

### 2. Configuration of Vehicle Display Device

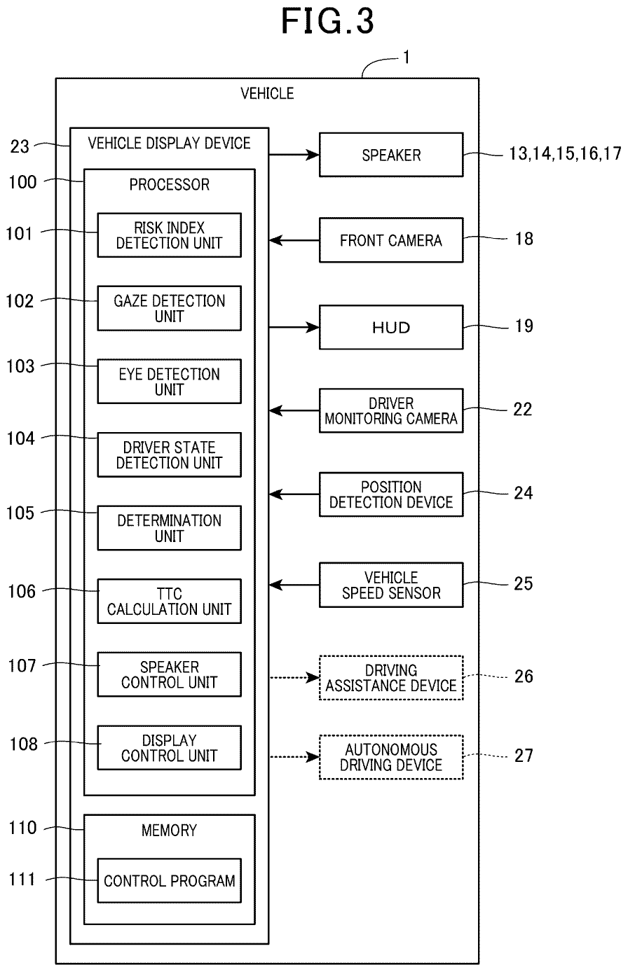

FIG. 3 is a diagram showing a configuration of the vehicle display device 23.

The vehicle display device 23 includes a processor 100 such as a CPU (Central Processing Unit) or an MPU (Micro-processing unit), a memory 110, and an interface circuit to which other devices and sensors are connected.

The processor 100 reads and executes a control program 111 stored in the memory 110 to control each part of the vehicle display device 23. The processor 100 executes a control program 111 stored in the memory 110 to function as a risk index detection unit 101, a gaze detection unit 102, an eye detection unit 103, a driver state detection unit 104, a determination unit 105, a TTC calculation unit 106, a speaker control unit 107, and a display control unit 108.

The risk index detection unit 101 is an example of a “detection unit”. The speaker control unit 107 is an example of a “stimulus control unit”.

The memory 110 is a storage device that stores programs executed by the processor 100 and data processed by the processor 100. The memory 110 stores a control program 111 executed by the processor 100 and various other data. The memory 110 has a non-volatile storage area. The memory 110 also includes a volatile storage area and constitutes the work area of the processor 100. The memory 110 is composed of, for example, a ROM (Read Only Memory) or a RAM (Random Access Memory).

The control program 111 corresponds to a “program”.

The speaker 17, the front camera 18, the HUD 19, the driver monitoring camera 22, a position detection device 24, and a vehicle speed sensor 25 are connected to the vehicle display device 23. When the vehicle 1 has a driving assistance function, a driving assistance device 26 (computer) is connected to the vehicle display device 23. When the vehicle 1 has an autonomous driving function, an autonomous driving device 27 (computer) is connected to the vehicle display device 23. Note that the devices connected to the vehicle display device 23 are not limited to these, and other devices such as a vehicle-to-vehicle communication device for vehicle-to-vehicle communication, a GNSS (Global Navigation Satellite System) unit, a rear camera, and the like may be connected.

The position detection device 24 is a device that can detect the position of an object present around the vehicle 1. The position detection device 24 is composed of at least one of, for example, a sonar, a radar, and a lidar capable of measuring the distance between the vehicle 1 and an object, and a stereo camera capable of measuring the distance between the vehicle 1 and an object using parallax.

The vehicle speed sensor 25 is a sensor that detects the speed of the vehicle 1. The vehicle speed sensor 25 detects the speed of the vehicle 1 at a predetermined cycle and outputs a signal corresponding to the detected speed of the vehicle 1 to the vehicle display device 23 each time the vehicle speed sensor 25 detects the speed.

The driving assistance device 26 is a device for executing a driving assistance function that assists the driver P in driving the vehicle 1. The driving assistance function executed by the driving assistance device 26 may include one or more of a collision damage reducing function, a lane departure prevention (lane keep assist) function, a straight driving assist function, and a rear side collision warning (blind spot monitor) function. The collision damage reducing function is a function that decelerates the vehicle 1 to avoid a collision or reduce collision damage when there is a possibility of a collision with an object ahead in the traveling direction. To achieve the above function, the driving assistance device 26 is connected to a front camera 18, a rear camera that captures images of the rear of the vehicle 1, a radar unit that detects objects around the vehicle 1, and the like.

The autonomous driving device 27 is a device that allows the vehicle 1 to execute an autonomous driving function.

As described above, the processor 100 of the vehicle display device 23 functions as the risk index detection unit 101, the gaze detection unit 102, the eye detection unit 103, the driver state detection unit 104, the determination unit 105, the TTC calculation unit 106, the speaker control unit 107, and the display control unit 108.

### 2-1. Risk Index Detection Unit

The risk index detection unit 101 detects the risk index 2 present in front of the vehicle 1. The risk index 2 refers to an index that may come into contact with the vehicle 1, such as another vehicle or a pedestrian. The risk index detection unit 101 detects the risk index 2 appearing in the captured image SG obtained by image capturing of the front camera 18 based on the image data of the captured image SG received from the front camera 18. The risk index detection unit 101 performs image processing based on pattern matching or color on the captured image SG to detect the risk index 2 appearing in the captured image SG.

Note that data required for detecting the risk index 2 (e.g., shape data and color data) is stored in the memory 110 for each type of risk index 2 to be detected.

The risk index detection unit 101 also detects the position of the detected risk index 2. More specifically, the risk index detection unit 101 detects the relative position of the risk index 2 with respect to the vehicle 1 when the vehicle 1 is viewed from above. The risk index detection unit 101 detects the relative position of the detected risk index 2 based on at least one of the detection results of the position detection device 24 and the captured image SG of the front camera 18. When the detected risk index 2 is another vehicle and a vehicle-to-vehicle communication device and a GNSS unit are connected to the vehicle display device 23, the risk index detection unit 101 may detect the relative position of the detected risk index 2 based on the position of the other vehicle received by the vehicle-to-vehicle communication device and the position of the vehicle 1 received by the GNSS unit.

In addition to the front camera 18, the vehicle-to-vehicle communication device, and the GNSS unit, the risk index detection unit 101 may detect the risk index 2 appearing in the captured image SG and may detect the relative position of the risk index 2 using communication such as V2X (road-to-vehicle, pedestrian-to-vehicle, etc.).

When the risk index detection unit 101 detects a risk index 2, it outputs data indicating the relative position of the detected risk index 2 with respect to the vehicle 1 to the determination unit 105 and the TTC calculation unit 106.

Furthermore, when the risk index detection unit 101 detects a risk index 2, it outputs data indicating the position of the detected risk index 2 in the captured image SG to the speaker control unit 107 and the display control unit 108.

### 2-2. Gaze Detection Unit

The gaze detection unit 102 detects the direction of the gaze of the driver P. The gaze detection unit 102 detects the gaze direction of the driver P based on image data of the captured image received from the driver monitoring camera 22. The gaze detection unit 102 detects the eyes of the driver P from the captured image obtained by image capturing with the driver monitoring camera 22 by pattern matching, color, etc., and detects the direction in which the detected eyes are facing as the gaze direction. In addition, data required for eye detection (eyes shape data and color data) is stored in the memory 110.

When the gaze detection unit 102 detects the direction of the driver P's gaze, it outputs data indicating the detected gaze direction to the display control unit 108.

### 2-3. Eye Detection Unit

The eye detection unit 103 detects the eyes of the driver P sitting in the driver's seat 10A. The eye detection unit 103 detects the eyes of the driver P based on image data of the captured image received from the driver monitoring camera 22. The eye detection unit 103 detects the head HD from the captured image obtained by image capturing with the driver monitoring camera 22 by pattern matching, color, etc. The eye detection unit 103 then detects the position of the eyes in the captured image by pattern matching, color, etc. Then, the eye detection unit 103 detects the position of the eyes in the up-down and left-right directions of the vehicle 1 based on the position of the eyes in the captured image. The position of the eyes in the captured image and the position of the eyes in the up-down direction of the vehicle 1 are determined by prior tests and simulations, and are stored as data in the memory 110.

### 2-4. Driver State Detection Unit

The driver state detection unit 104 detects whether the driver P sitting in the driver's seat 10A is in a normal state or an abnormal state. The driver state detection unit 104 detects whether the driver P is in a normal state or an abnormal state based on the image data of the captured image received from the driver monitoring camera 22.

More specifically, the driver state detection unit 104 detects the face of the driver P from the captured image obtained by image capturing with the driver monitoring camera 22 by pattern matching or the like. The driver state detection unit 104 then detects whether the face of the driver P detected from the captured image is the face of the driver P in a normal state or the face of the driver P in an abnormal state.

For example, when the face of the driver P detected from the captured image is a face with its eyes closed for a predetermined period of time or more, a face with anger, or a face in a hurry, the driver state detection unit 104 detects that the face of the driver P is in an abnormal state. Contrarily, for example, when the face of the driver P detected from the captured image is not a face with its eyes closed for a predetermined period of time or more, is not a face with anger, or is not a face in a hurry, the driver state detection unit 104 detects the face of the driver P is in a normal state. The type of the face is detected based on pattern matching or color.

When the driver state detection unit 104 detects that the face of the driver P detected from the captured image is a face of the driver P in a normal state, it detects that the state of the driver P is a normal state. Contrarily, when the driver state detection unit 104 detects that the face of the driver P detected from the captured image is a face of the driver P in an abnormal state, it detects that the state of the driver P is an abnormal state.

When the driver P wears a wearable device, the driver state detection unit 104 may receive biometric data of the driver P from the wearable device and detect whether the driver P is in a normal state or an abnormal state based on the received biometric data.

### 2-5. Determination Unit

The determination unit 105 determines whether a visibility-reducing image VG, which will be described later, can be displayed.

A plurality of examples of the determination method of the determination unit 105 will be given below.

### 2-5-1. Determination Method 1

In a determination method 1, the determination unit 105 determines whether the visibility-reducing image VG can be displayed based on information about the road on which the vehicle 1 is running. For example, when the road on which the vehicle 1 is running is an expressway, the determination unit 105 determines that the visibility-reducing image VG cannot be displayed, and when the road on which the vehicle 1 is running is a general road, the determination unit 105 determines that the visibility-reducing image VG can be displayed. As will be clear later, the vehicle display device 23 increases the possibility that the driver P successfully recognizes the risk index 2 by displaying the visibility-reducing image VG. As a result, depending on the position of the risk index 2, the driver P will look aside. Therefore, in the case of an expressway where the speed of the vehicle 1 is estimated to be high, the determination unit 105 determines that the visibility-reducing image VG cannot be displayed, and in the case of a general road where the speed of the vehicle 1 is estimated to be low, the determination unit 105 determines that the visibility-reducing image VG can be displayed.

The determination unit 105 may acquire information about the road on which the vehicle 1 is running from map data stored in the memory 110, or may acquire information about the road on which the vehicle 1 is running from an external server by communicating with the external server.

### 2-5-2. Determination Method 2

In a determination method 2, the determination unit 105 determines whether the visibility-reducing image VG can be displayed based on the time until contact with the risk index 2. Hereinafter, the time until contact with the risk index 2 will be appropriately expressed as TTC (Time to Collision). The determination unit 105 calculates the TTC when determining whether the visibility-reducing image VG can be displayed.

The calculation of the TTC will now be described.

In calculating the TTC, the determination unit 105 calculates the separation distance between the vehicle 1 and the risk index 2 and the relative speed between the vehicle 1 and the risk index 2.

For example, the determination unit 105 calculates the separation distance between the vehicle 1 and the risk index 2 based on the data indicating the relative position received from the risk index detection unit 101.

In addition, for example, the determination unit 105 calculates the relative speed between the vehicle 1 and the risk index 2 based on the data indicating a plurality of relative positions received from the risk index detection unit 101 and the detection result of the vehicle speed sensor 25.

For example, it is assumed that a vehicle-to-vehicle communication device and a GNSS unit are connected to the vehicle display device 23, and the risk index 2 detected by the risk index detection unit 101 is another vehicle. In this case, the determination unit 105 calculates the relative speed between the vehicle 1 and the risk index 2 and the separation distance between the vehicle 1 and the risk index 2 based on the speed of the vehicle 1 detected by the vehicle speed sensor 25, the position of the vehicle 1 received by the GNSS unit, and the position of another vehicle and speed of another vehicle received by the vehicle-to-vehicle communication device.

When the determination unit 105 calculates the separation distance between the vehicle 1 and the risk index 2 and the relative speed between the vehicle 1 and the risk index 2, it calculates the TTC by dividing the calculated separation distance by the calculated relative speed.

When the calculated TTC is shorter than a predetermined value (e.g., 7 seconds), the determination unit 105 determines that the visibility-reducing image VG can be displayed, and when the calculated TTC is equal to or longer than the predetermined value, the determination unit 105 determines that the visibility-reducing image VG cannot be displayed. Note that the predetermined value of 7 seconds is merely an example. This predetermined value is not limited to 7 seconds, and may be a value longer than 7 seconds or a value shorter than 7 seconds. The predetermined value is appropriately determined by prior tests and simulations.

### 2-5-3. Determination Method 3

In a determination method 3, the determination unit 105 determines whether the visibility-reducing image VG can be displayed based on the distance from the viewpoint P1 of the driver P on the windshield 20 to the risk index 2 (hereinafter referred to as the viewpoint-to-index distance).

The determination unit 105 calculates the viewpoint-to-index distance when making this determination.

Now, the calculation of the viewpoint-to-index distance will be described with reference to FIG. 4.

FIG. 4 is a diagram for describing the calculation of the viewpoint-to-index distance.

The determination unit 105 detects the viewpoint P1 of the driver P on the windshield 20 based on the direction of the gaze indicated by the data received from the gaze detection unit 102. For example, when the memory 110 stores data in which the direction of the driver P's gaze is associated with the driver P's viewpoint P1 on the windshield 20, the determination unit 105 refers to the data to detect the driver P's viewpoint P1 on the windshield 20. The determination unit 105 loads a coordinate system, in which the shape, size, and up-down and left-right directions of the displayable area A1 are defined, to the memory 110, and determines the viewpoint P1 by referring to the loaded coordinate system.

The determination unit 105 then determines the risk index position P2. The risk index position P2 is a position of the risk index 2 on the windshield 20 as seen by the driver P. The determination unit 105 loads a coordinate system, in which the shape, size, and up-down and left-right directions of the displayable area A1 are defined, to the memory 110, and determines the risk index position P2 by referring to the loaded coordinate system.

In determining the risk index position P2, the determination unit 105 determines the risk index position P2 in the up-down direction of the displayable area A1 (hereinafter, expressed as the “first risk index position P2-1” with the reference character “P2-1”). The up-down direction of the displayable area A1 corresponds to the up-down direction of the windshield 20 and the short-side direction of the displayable area A1.

In addition, in determining the risk index position P2, the determination unit 105 determines the risk index position P2 in the left-right direction of the displayable area A1 (hereinafter, expressed as the “second risk index position P2-2” with the reference character “P2-2”). The left-right direction of the displayable area A1 corresponds to the left-right direction of the windshield 20 and the longitudinal direction of the displayable area A1.

First, the determination of the first risk index position P2-1 will be described.

The determination unit 105 acquires the position of the risk index 2 in the up-down direction of the captured image SG from the data output by the risk index detection unit 101. The up-down direction of the captured image SG corresponds to the up-down direction of the scene captured in the captured image SG. The determination unit 105 then converts the position of the acquired risk index 2 into a position in the up-down direction of the displayable area A1, and determines the converted position to be the first risk index position P2-1. The relationship between the position in the up-down direction of the captured image SG and the position in the up-down direction of the displayable area A1 is determined by prior simulations, etc., and is stored as data in the memory 110.

Next, the determination of the second risk index position P2-2 will be described.

The determination unit 105 acquires the position of the risk index 2 in the left-right direction of the captured image SG from the data output by the risk index detection unit 101. The left-right direction of the captured image SG is perpendicular to the up-down direction of the captured image SG. Then, the determination unit 105 converts the acquired position of the risk index 2 into a position in the left-right direction of the displayable area A1. The relationship between the position in the left-right direction of the captured image SG and the position in the left-right direction of the displayable area A1 is determined by prior tests, simulations, etc., and is stored as data in the memory 110.

After the conversion into a position in the left-right direction of the displayable area A1, the determination unit 105 corrects the converted position in the left-right direction of the displayable area A1 based on the position of the eyes detected by the eye detection unit 103. For example, when the position of the eyes is to the left of a predetermined reference in the left-right direction of the vehicle 1, the determination unit 105 corrects the converted position to the left in accordance with the distance between the predetermined reference and the position of the eyes in the left-right direction. Contrarily, for example, when the position of the eyes is to the right of a predetermined reference in the left-right direction of the vehicle 1, the determination unit 105 corrects the converted position to the right in accordance with the distance between the predetermined reference and the position of the eyes.

The determination unit 105 then determines the corrected position to be the second risk index position P2-2.

When determining the first risk index position P2-1 and the second risk index position P2-2, the determination unit 105 determines the position defined by the first risk index position P2-1 and the second risk index position P2-2 as the risk index position P2.

When determining the viewpoint P1 and the risk index position P2, the determination unit 105 calculates the distance L2 between the viewpoint P1 and the risk index position P2 on the windshield 20 as the viewpoint-to-index distance.

The determination unit 105 calculates the distance on a line between the viewpoint P1 and the risk index position P2 in the coordinate system loaded to the memory 110, and converts this to a distance on the windshield 20, thereby calculating the viewpoint-to-index distance.

When calculating the viewpoint-to-index distance, the determination unit 105 determines whether the viewpoint-to-index distance is equal to or longer than a predetermined distance. The determination unit 105 determines that the visibility-reducing image VG cannot be displayed when the viewpoint-to-index distance is equal to or shorter than a predetermined distance, and the determination unit 105 determines that the visibility-reducing image VG can be displayed when the viewpoint-to-index distance is longer than the predetermined distance.

### 2-5-4. Determination Method 4

In a determination method 4, the determination unit 105 determines whether the visibility-reducing image VG can be displayed based on the state of the driver P. When the driver state detection unit 104 determines that the driver P is in a normal state, the determination unit 105 determines that the visibility-reducing image VG can be displayed. Contrarily, when the driver state detection unit 104 determines that the driver P is in an abnormal state, the determination unit 105 determines that the visibility-reducing image VG cannot be displayed.

### 2-5-5. Determination Method 5

In a determination method 5, the determination unit 105 determines whether the visibility-reducing image VG can be displayed based on the presence or absence of a driving assistance function of the vehicle 1. When the vehicle 1 has a driving assistance function, the determination unit 105 determines that the visibility-reducing image VG can be displayed. Contrarily, when the vehicle 1 does not have a driving assistance function, the determination unit 105 determines that the visibility-reducing image VG cannot be displayed. Whether the vehicle 1 has a driving assistance function is stored as data in the memory 110. Then, the determination unit 105 refers to the data stored in the memory 110 to determine whether the visibility-reducing image VG can be displayed.

As described above, examples of the determination method of the determination unit 105 have been given. The determination unit 105 may determine whether the visibility-reducing image VG can be displayed through any of the determination methods 1 to 5, or may determine whether the visibility-reducing image VG can be displayed by combining any of the processing of the determination methods 1 to 5.

### 2-6. TTC Calculation Unit

The TTC calculation unit 106 calculates a TTC. The TTC calculation unit 106 calculates a TTC through the same calculation method as the determination unit 105.

### 2-7. Speaker Control Unit

The speaker control unit 107 operates the speaker 17 to output sound to the driver P.

### 2-8. Display Control Unit

The display control unit 108 controls the operation of the HUD 19 to momentarily display the visibility-reducing image VG on the windshield 20. The visibility-reducing image VG is an image that reduces the visibility for the driver P through the windshield 20. The display control unit 108 displays the visibility-reducing image VG by performing the following processing.

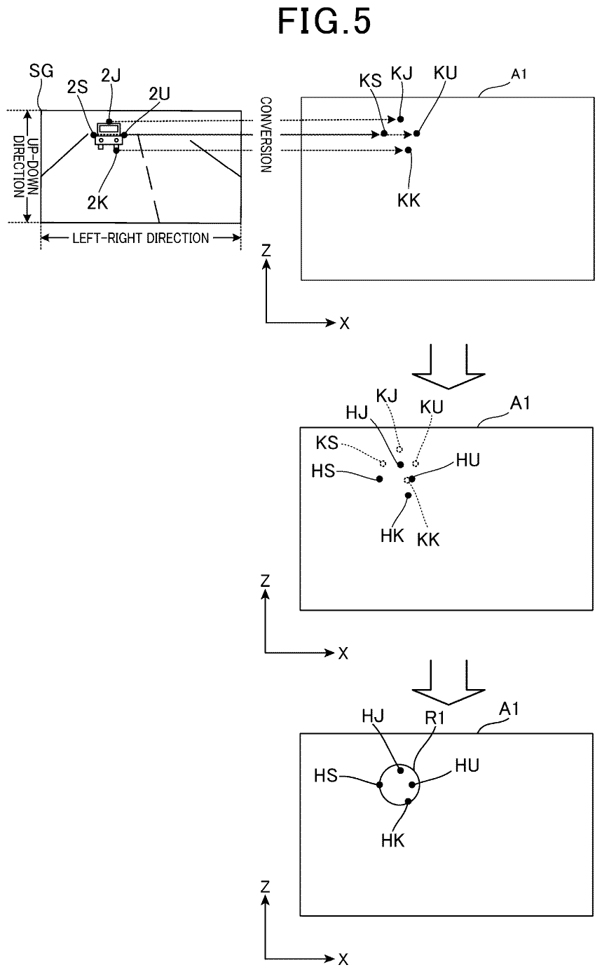

The processing of the display control unit 108 will be described with reference to FIG. 5.

FIG. 5 is a diagram for describing the processing of the display control unit 108.

The display control unit 108 acquires the upper end position 2J and the lower end position 2K of the risk index 2 in the captured image SG from the data detected by the risk index detection unit 101. Furthermore, the display control unit 108 acquires the left end position 2S and the right end position 2U of the risk index 2 in the captured image SG from the data detected by the risk index detection unit 101.

The display control unit 108 then converts the acquired upper end position 2J into a position in the up-down direction of the displayable area A1. This converted position is referred to as a converted upper end position KJ with a reference character “KJ” added.

The display control unit 108 converts the acquired lower end position 2K into a position in the up-down direction of the displayable area A1. This converted position is referred to as a converted lower end position KK with a reference character “KK” added.

The display control unit 108 converts the acquired left end position 2S into a position in the left-right direction of the displayable area A1. This converted position is referred to as a converted left end position KS with a reference character “KS” added.

The display control unit 108 converts the acquired right end position 2U into a position in the left-right direction of the displayable area A1. This converted position is referred to as a converted right end position KU with a reference character “KU” added.

The relationship between the position of the captured image SG in the up-down and left-right directions and the position in the up-down and left-right directions of the displayable area A1 is determined by prior simulations, etc., and is stored as data in the memory 110. Then, the display control unit 108 converts the four positions acquired from the captured image SG with reference to the data stored in the memory 110.

Next, the display control unit 108 corrects the converted upper end position KJ, the converted lower end position KK, the converted left end position KS, and the converted right end position KU based on the position of the eyes detected by the eye detection unit 103. The display control unit 108 loads a coordinate system, in which the shape, size, and up-down and left-right directions of the displayable area A1 are defined, to the memory 110, and plots the converted upper end position KJ, the converted lower end position KK, the converted left end position KS, and the converted right end position KU in the loaded coordinate system, and then corrects these four positions.

For example, when the position of the eyes is higher than a predetermined reference in the up-down direction of the vehicle 1, the display control unit 108 corrects the converted upper end position KJ and the converted lower end position KK downward in the up-down direction of the displayable area A1 in accordance with the distance between the predetermined reference and the position of the eyes.

For example, when the position of the eyes is lower than a predetermined reference in the up-down direction of the vehicle 1, the display control unit 108 corrects the converted upper end position KJ and the converted lower end position KK upward in the up-down direction of the displayable area A1 in accordance with the distance between the predetermined reference and the position of the eyes.

For example, when the position of the eyes is to the left of a predetermined reference in the left-right direction of the vehicle 1, the display control unit 108 corrects the converted left end position KS and the converted right end position KU to the left in the left-right direction of the displayable area A1 in accordance with the distance between the predetermined reference and the position of the eyes.

For example, when the position of the eyes is to the right of a predetermined reference in the left-right direction of the vehicle 1, the display control unit 108 corrects the converted left end position KS and the converted right end position KU to the right in the left-right direction of the displayable area A1 in accordance with the distance between the predetermined reference and the position of the eyes.

Hereinafter, the corrected converted upper end position KJ is referred to as a corrected upper end position HJ with a reference character “HJ” added. The corrected converted lower end position KK is hereinafter referred to as the corrected lower end position HK with the reference character “HK” added. The corrected converted left end position KS is hereinafter referred to as the corrected left end position HS with the reference character “HS” added. The corrected converted right end position KU is hereinafter referred to as the corrected right end position HU with the reference character “HU” added.

Next, the display control unit 108 determines a risk index range R1. The risk index range R1 is a range on the windshield 20 that corresponds to the risk index 2. The display control unit 108 loads a coordinate system, in which the shape, size, and up-down and left-right directions of the displayable area A1 are defined, to the memory 110, and plots the corrected upper end position HJ, the corrected lower end position HK, the corrected left end position HS, and the corrected right end position HU in the loaded coordinate system, and then determines the risk index range R1.

The display control unit 108 determines a range of a circle as the risk index range R1. The circle is defined such that at least one of the corrected upper end position HJ, the corrected lower end position HK, the corrected right end position HU, and the corrected left end position HS is located on the circumference of the circle and these four positions are included within the circle.

Note that the shape of the risk index range R1 is not limited to a circle. For example, the display control unit 108 may determine a rectangular range obtained by connecting the corrected upper end position HJ, the corrected lower end position HK, the corrected right end position HU, and the corrected left end position HS with straight lines as the risk index range R1.

Furthermore, the risk index range R1 does not have to be a range in which at least any of the corrected upper end position HJ, the corrected lower end position HK, the corrected right end position HU, and the corrected left end position HS is located on the circumference of a circle. For example, the risk index range R1 may be a range in which all of the corrected upper end position HJ, the corrected lower end position HK, the corrected right end position HU, and the corrected left end position HS are included within a circle.

As described above, the display control unit 108 can determine the risk index range R1, thereby determining the risk index range R1 to be a range based on the position and size of the risk index 2 and the position of the eyes of the driver P in the vehicle 1.

The display control unit 108 may determine the risk index range R1 taking into account information about the road on which the vehicle 1 is running. In this case, the display control unit 108 acquires information about the road on which the vehicle 1 is running from the map data stored in the memory 110 or from an external server, and determines the risk index range R1.

For example, when the road on which the vehicle 1 is running is a general road, the display control unit 108 may determine the risk index range R1 to be the above-described risk index range R1 in which at least one of the four positions is located on the circumference of the circle, and when the road on which the vehicle 1 is running is an expressway, the display control unit 108 may determine the risk index range R1 to be a range with a larger radius than the range in the case of a general road.

In addition, for example, when the width of the road on which the vehicle 1 is running is equal to or greater than a predetermined value, the display control unit 108 may determine the risk index range R1 to be the above-described risk index range R1 in which at least one of the four positions is located on the circumference of the circle, and when the width of the road on which the vehicle 1 is running is smaller than a predetermined value, the display control unit 108 may determine the risk index range R1 to be a range with a larger radius than when the road width is equal to or greater than the predetermined value.

When the risk index 2 detected by the risk index detection unit 101 includes a person and an object other than a person (e.g., a motorcycle and its driver), the display control unit 108 determines a risk index range R1 including the person or the object other than the person based on information about the road on which the vehicle 1 is running.

In this case, the display control unit 108 acquires information about the road on which the vehicle 1 is running from the map data stored in the memory 110 or from an external server, and determines the risk index range R1. In this case, the display control unit 108 acquires four positions from the captured image SG for a person or an object other than the person, and determines the risk index range R1.

For example, when the road on which the vehicle 1 is running is a general road, the display control unit 108 determines the risk index range R1 to be the risk index range R1 including a person, and when the road on which the vehicle 1 is running is an expressway, the display control unit 108 determines the risk index range R1 to be the risk index range R1 including an object other than a person.

When the display control unit 108 determines the risk index range R1, it displays the visibility-reducing image VG in the displayable area A1 in a range other than the determined risk index range R1.

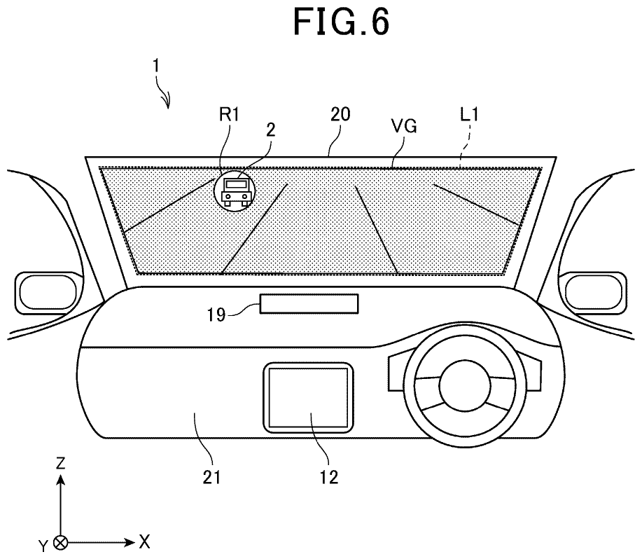

FIG. 6 is a diagram showing an example of a visibility-reducing image VG.

As described above, the visibility-reducing image VG is an image that reduces the visibility for the driver P through the windshield 20. The visibility-reducing image VG is displayed in the displayable area A1 in a range other than the risk index range R1. The visibility-reducing image VG is an image with a lower transmittance than the windshield 20. The transmittance of the visibility-reducing image VG is set to a transmittance that allows the driver P to see the scene through the windshield 20 even through the visibility-reducing image VG.

As described above, the display control unit 108 momentarily displays the visibility-reducing image VG on the windshield 20. This allows the risk index 2 to be momentarily highlighted on the windshield 20, and the driver P can be given a stimulus regarding the risk index 2 in such a short time that the driver P is not aware of it. In other words, an effect similar to a subliminal effect can be provided on the driver P regarding the risk index 2. This prevents the annoyance of an image being displayed on the windshield 20, and increases the possibility that the driver P successfully recognizes the risk index 2.

### 3. Operation of Vehicle Display Device

Next, the operation of the vehicle display device 23 according to this embodiment will be described.

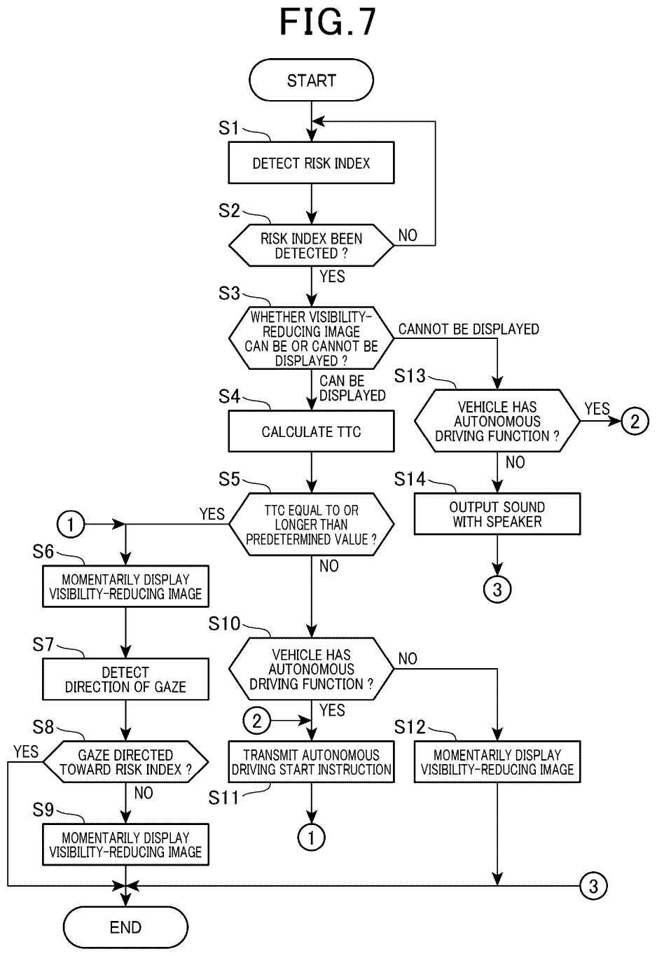

FIG. 7 is a flowchart showing operation of the vehicle display device 23.

The risk index detection unit 101 detects a risk index 2 present in front of the vehicle 1 (step S1).

Step S1 corresponds to a “detection step”.

The determination unit 105 determines whether a risk index 2 is detected in step S1 (step S2). The determination in step S2 is made based on whether data is received from the risk index detection unit 101.

If the determination unit 105 determines that risk index 2 has not been detected (step S2: NO), the processor 100 returns the process to step S1 and performs the process of step S1 again.

Contrarily, if it is determined that risk index 2 has been detected (step S2: YES), the determination unit 105 determines whether the visibility-reducing image VG can be or cannot be displayed (step S3).

If the determination unit 105 determines that the visibility-reducing image VG can be displayed (step S3: displayable), the TTC calculation unit 106 calculates the TTC for the risk index 2 detected by the risk index detection unit 101 (step S4).

Next, the display control unit 108 determines whether the TTC calculated in step S4 is equal to or longer than a predetermined value (step S5). This predetermined value is set to a value greater than the predetermined value to be used by the determination unit 105 in determination method 2, and is, for example, 8 seconds.

If the display control unit 108 determines that the TTC calculated in step S4 is equal to or longer than a predetermined value (step S5: YES), it momentarily displays the visibility-reduced image VG (step S6).

Step S6 corresponds to a “display step”.

In step S6, the display control unit 108 displays the visibility-reducing image VG for a first period of time. The first period of time is shorter than the second period of time described later, and is, for example, 0.03 seconds. Note that this example of the first period of time is merely an example and is not limited to 0.03 seconds. The first period of time only needs to be shorter than the second period of time and only needs to be a time that can be regarded as momentary (e.g., 0.5 seconds or less).

The gaze detection unit 102 then detects the direction of the driver P's gaze (step S7).

The display control unit 108 then determines whether the driver P's gaze is directed toward the risk index 2 (step S8).

In step S8, the display control unit 108 makes a determination based on the direction of the gaze detected in step S7 and the position of the risk index 2 in the captured image SG indicated by the data received from the risk index detection unit 101.

If the display control unit 108 determines that the gaze of the driver P is directed toward the risk index 2 (step S8: YES), the processor 100 ends this processing.

In contrast, if the display control unit 108 determines that the gaze of the driver P is not directed toward the risk index 2 (step S8: NO), it momentarily displays the visibility-reducing image VG (step S9).

Step S9 corresponds to a “display step”.

In step S9, the display control unit 108 displays the visibility-reducing image VG for a second period of time. The second period of time is a time longer than the first period of time described later, and is, for example, 0.5 seconds. The example time of the second period of time is merely an example, and is not limited to 0.5 seconds.

The second period of time only needs to be longer than the first period of time and only needs to be a time that can be regarded as momentary (e.g., 0.5 seconds or less).

In addition, in step S9, the display control unit 108 displays a visibility-reducing image VG in which the visibility for the driver P is reduced more than the visibility-reducing image VG to be displayed in step S6.

Returning to the description of step S5, if the display control unit 108 determines that the TTC calculated in step S4 is shorter than a predetermined value (step S5: NO), it determines whether the vehicle 1 has an autonomous driving function (step S10).

Step S10 will be described in detail. Whether or not the vehicle 1 has an autonomous driving function is stored as data in the memory 110. Then, the display control unit 108 determines whether the vehicle 1 has an autonomous driving function by referring to the data stored in the memory 110.

If determining that the vehicle 1 has an autonomous driving function (step S10: YES), the display control unit 108 transmits an autonomous driving start instruction to instruct the autonomous driving device 27 to start autonomous driving (step S11). As a result, the display control unit 108 enables the autonomous driving function of the vehicle 1.

Next, the processor 100 shifts the process to step S6, and executes the processes from step S6 onwards.

In contrast, if determining that the vehicle 1 does not have an autonomous driving function (step S10: NO), the display control unit 108 momentarily displays the visibility-reducing image VG (step S12). In step S12, the display control unit 108 displays the visibility-reducing image VG for the first period of time.

Step S12 corresponds to a “display step”.

Returning to the description of step S3, if the determination unit 105 determines that the visibility-reducing image VG cannot be displayed (step S3: cannot be displayed), the display control unit 108 determines whether the vehicle 1 has an autonomous driving function (step S13). The determination in step S13 is performed in the same manner as the determination in step S10.

If the display control unit 108 determines that the vehicle 1 has an autonomous driving function (step S13: YES), the processor 100 shifts the process to step S6 and executes the processes from step S6 onwards.

In contrast, if the display control unit 108 determines that the vehicle 1 does not have an autonomous driving function (step S13: NO), the speaker control unit 107 outputs sound through the speaker 17 (step S14).

Step S14 will be described in detail.

The speaker control unit 107 selects the speaker 17 that outputs sound based on the position of the risk index 2 in the captured image SG indicated by the data received from the risk index detection unit 101. For example, if the position of the risk index 2 in the captured image SG is to the left of the range that can be regarded as the center in the left-right direction of the captured image SG, the speaker control unit 107 selects speaker 14 as the speaker 17 that outputs sound. For example, when the position of the risk index 2 in the captured image SG is within a range that can be regarded as the center in the left-right direction of the captured image SG, the speaker control unit 107 selects the speakers 14 and 15 as the speaker 17 that outputs sound. For example, if the position of the risk index 2 in the captured image SG is to the right of the range that can be regarded as the center in the left-right direction of the captured image SG, the speaker control unit 107 selects speaker 15 as the speaker 17 that outputs sound.

The speaker control unit 107 then outputs sound from the selected speaker 17.

If sound of content or the like is being output from the speaker 17 when step S14 is performed, the speaker control unit 107 mutes the sound of the content or the like and outputs sound from the selected speaker 17.

### 4. Other Embodiments

The above-described embodiment shows only an aspect, and can be modified and applied as desired.

In the above-described embodiment, the speaker 17 is illustrated as the “stimulus output device”, and sound is output as the “stimulus”. In other words, in the above-described embodiment, when the determination unit 105 determines that the visibility-reducing image VG cannot be displayed and the display control unit 108 does not display the visibility-reducing image VG, the speaker 17 outputs sound to the driver P. However, the type of “stimulus” given to the driver P in this case is not limited to sound, and may be, for example, vibration. For example, in another embodiment, a vibration output device that vibrates the steering wheel or the driver's seat 10A may be connected to the vehicle display device 23. Here, when the determination unit 105 determines that the visibility-reducing image VG cannot be displayed and the display control unit 108 does not display the visibility-reducing image VG, the vibration output device may apply vibration to the driver P.

In another embodiment, when the TTC calculated by the TTC calculation unit 106 is shorter than a predetermined value, the display control unit 108 may display no visibility-reducing image VG on the windshield 20, but may display the risk index range R1 on the windshield 20 in an emphasized manner. In the other embodiment, the display control unit 108 may, for example, display the risk index range R1 in an emphasized manner by displaying the entire area of risk index range R1 in a predetermined color, or may display the risk index range R1 in an emphasized manner by displaying the edge of the risk index range R1 in a predetermined color. In addition, in the case of the other embodiment, when the TTC calculated by the TTC calculation unit 106 is shorter than a predetermined value, the display control unit 108 may display the risk index range R1 on the windshield 20 in an emphasized manner, regardless of the determination result of the determination unit 105. It is preferable that this predetermined value be set to a value shorter than the predetermined value to be compared in step S5.

In the above-described embodiment, a four-wheeled vehicle 1 is used as an example of a “vehicle”, but the number of wheels is not limited to four as long as the “vehicle” has a windshield 20.

In the above-described embodiment, an image is displayed on the windshield 20 by the HUD 19. However, means for displaying the image on the windshield 20 may be any means for displaying a virtual image on the windshield 20, is not limited to the HUD 19, and may be display means such as an LED (Light Emitting Diode).

The processor 100 may be composed of a plurality of processors or may be composed of a single processor. The processor 100 may be hardware programmed to implement the above-described functional units. In this case, the processor 100 is composed, for example, of an ASIC (Application Specific Integrated Circuit) or an FPGA (Field Programmable Gate Array).

Furthermore, the configuration of each part of the vehicle 1 shown in FIG. 3 is an example, and the specific implementation form is not particularly limited. In other words, it is not necessarily necessary to implement hardware that corresponds to each part individually, and it is of course possible to have a configuration such that one processor executes a program to implement the function of each part. Furthermore, some of the functions implemented by software in the above-described embodiment may be implemented by hardware, or some of the functions implemented by hardware may be implemented by software.

Furthermore, the step units of the operation shown in FIG. 7 are divided in accordance with the main processing contents, and the present invention is not limited by the manner in which the processing units are divided or the names. The processing may be divided into more step units depending on the processing contents. Furthermore, one step unit may be divided so as to include further more processes. The order of the steps may be changed as appropriate without interfering with the spirit of the present invention.

When the above-described control method of the vehicle display device 23 is implemented using the processor 100, it is also possible to implement the program executed by the processor 100 in the form of a recording medium or a transmission medium that transmits this program. In other words, the control program 111 can also be implemented in a state in which the control program 111 is recorded on a portable information recording medium. The information recording medium may be a magnetic recording medium such as a hard disk, an optical recording medium such as a CD, or a semiconductor storage device such as a Universal Serial Bus (USB) memory or a Solid State Drive (SSD), but other recording media can also be used.

The above embodiment supports the following configuration.

### Configuration 1

A vehicle display device, including: a detection unit that detects a risk index that is present in front of a vehicle and has a possibility of coming into contact with the vehicle; and a display control unit that displays an image on a windshield of the vehicle, wherein the display control unit momentarily displays a visibility-reducing image on the windshield in a range other than a risk index range corresponding to the risk index detected by the detection unit, the visibility-reducing image reducing visibility for a driver of the vehicle.

The vehicle display device of configuration 1 makes it possible to momentarily highlight the risk index on the windshield, and to give a stimulus to the driver regarding the risk index in a short time. This therefore makes it possible to reduce the annoyance of an image being displayed on the windshield and increase the possibility that the driver successfully recognizes the risk index.

### Configuration 2

The vehicle display device according to configuration 1, further including a determination unit that determines whether the visibility-reducing image can be displayed, wherein the determination unit determines whether the visibility-reducing image can be displayed based on at least one of the following: information about a road on which the vehicle is running, a period of time until contact with the risk index, a distance from a viewpoint of the driver on the windshield to the risk index, a state of the driver, and presence or absence of a driving assistance function of the vehicle.

Depending on the road on which the vehicle is running, it may be preferable not to display the visibility-reducing image. Depending on the time until contact with the risk index, it may be preferable not to display the visibility-reducing image. Depending on the distance between the driver's viewpoint on the windshield and the risk index, it may be preferable not to display the visibility-reducing image. Depending on the driver's state, it may be preferable not to display the visibility-reducing image. Depending on whether the vehicle has a driving assistance function, it may be preferable not to display the visibility-reducing image. The configuration 2 therefore makes it possible to display the visibility-reducing image in an appropriate situation.

### Configuration 3

The vehicle display device according to configuration 2, wherein the display control unit displays the visibility-reducing image for a first period of time when the determination unit determines that the visibility-reducing image can be displayed, and displays the visibility-reducing image for a second period of time longer than the first period of time when a gaze of the driver is not directed toward the risk index after the visibility-reducing image is displayed for the first period of time.

The vehicle display device of configuration 3 momentarily displays the visibility-reducing image again if the driver's gaze is not directed toward the risk index. This therefore makes it possible to further increase the possibility that the driver successfully recognizes the risk index while reducing the unnecessary display of an image on the windshield.

### configuration 4

The vehicle display device according to configuration 3, wherein the visibility-reducing image displayed in the second period of time is an image that reduces visibility for the driver more than the visibility-reducing image displayed in the first period of time.

The vehicle display device of configuration 4 makes it possible to highlight the risk index more than the visibility-reducing image displayed for the first period of time, therefore further increase the possibility that the driver successfully recognizes the risk index.

### Configuration 5

The vehicle display device according to any one of configurations 2 to 4, wherein when the determination unit determines that the visibility-reducing image cannot be displayed, and when the vehicle has an autonomous driving function, the display control unit enables the autonomous driving function and displays the visibility-reducing image.

The vehicle display device of configuration 5 makes it possible to display visibility-reducing images for many risk indexes compared to a case in which the vehicle does not have an autonomous driving function, and increase possibility that the driver successfully recognizes a large number of risk indexes.

### Configuration 6

The vehicle display device according to any one of configurations 2 to 5, wherein the vehicle display device is connected to a stimulus output device for outputting a stimulus other than a display to the driver and includes a stimulus control unit for controlling the stimulus output device, and when the determination unit determines that the visibility-reducing image cannot be displayed and when the vehicle does not have an autonomous driving function, the display control unit does not display the visibility-reducing image and the stimulus control unit causes the stimulus output device to output the stimulus.

The vehicle display device of configuration 6 makes it possible to give a stimulus to increase the possibility that the driver successfully recognizes the risk index even when the visibility-reducing image cannot be displayed.

### Configuration 7

The vehicle display device according to any one of configurations 1 to 6, wherein the risk index range is a range based on a position and a size of the risk index and a position of the eyes of the driver in the vehicle.

The vehicle display device of configuration 7 makes it possible to appropriately highlight the risk index without causing a sense of discomfort to the driver when the driver looks at the windshield, and further increase the possibility that the driver successfully recognizes the risk index.

### Configuration 8

The vehicle display device according to configuration 7, wherein the risk index range is a range based on information about a road on which the vehicle is running.

The vehicle display device of configuration 8 makes it possible to set the risk index range to a range taking into account information about the road on which the vehicle is running, and highlight the risk index in accordance with the road on which the vehicle is running. This further increases the possibility that the driver successfully recognizes the risk index.

### Configuration 9

The vehicle display device according to configuration 8, wherein when the risk index includes a person and an object other than a person, the display control unit displays the visibility-reducing image so that the person or the object is included in the risk index range based on information about a road on which the vehicle is running.

The vehicle display device of configuration 9 makes it possible to highlight the risk index in accordance with the road on which the vehicle is running when the risk index includes a person and an object other than the person.

### Configuration 10

The vehicle display device according to any one of configurations 1 to 9, wherein when a time until the vehicle comes in contact with the risk index is equal to or shorter than a predetermined value, the display control unit displays the risk index range in an emphasized manner.

The vehicle display device of configuration 10 makes it possible to increase the possibility that the driver successfully recognizes the risk index when there is a high possibility of contact with the risk index, and increase the possibility of avoiding contact between the risk index and the vehicle.

### Configuration 11

A method for controlling the vehicle display device, including: a detection step of detecting a risk index that is present in front of a vehicle and has a possibility of coming into contact with the vehicle; and a display step of displaying an image on a windshield of the vehicle, wherein the display step momentarily displays a visibility-reducing image on the windshield in a range other than a risk index range corresponding to the risk index detected in the detection step, the visibility-reducing image reducing visibility for a driver of the vehicle.

The method for controlling the vehicle display device of configuration 11 provide the same effect as the vehicle display device of configuration 1.

### Configuration 12

A non-transitory computer readable recording medium recording a program including causing a processor to function as: a detection unit that detects a risk index that is present in front of a vehicle and has a possibility of coming into contact with the vehicle; and a display control unit that displays an image on a windshield of the vehicle, wherein the display control unit momentarily displays a visibility-reducing image on the windshield in a range other than a risk index range corresponding to the risk index detected by the detection unit, the visibility-reducing image reducing visibility for a driver of the vehicle.

The recording medium of configuration 12 provides the same effect as the vehicle display device of configuration 1.

### REFERENCE SIGNS LIST

1 . . . vehicle, 2 . . . risk index, 2J . . . upper end position, 2K . . . lower end position, 2S . . . left end position, 2U . . . right end position, 10A . . . driver's seat, 10B . . . passenger seat, 10C . . . rear right seat, 10D . . . rear left seat, 12 . . . touch panel, 13, 14, 15, 16, 17 . . . speaker (stimulus output device), 18 . . . front camera, 19 . . . HUD, 20 . . . windshield, 21 . . . instrument panel, 22 . . . driver monitoring camera, 23 . . . vehicle display device, 24 . . . position detection device, 25 . . . vehicle speed sensor, 26 . . . driving assistance device, 27 . . . autonomous driving device, 100 . . . processor, 101 . . . risk index detection unit (detection unit), 102 . . . gaze detection unit, 103 . . . eye detection unit, 104 . . . driver state detection unit, 105 . . . determination unit, 106 . . . TTC calculation unit, 107 . . . speaker control unit (stimulus control unit), 110 . . . memory, 111 . . . control program, HD . . . head, HJ . . . corrected upper end position, HK . . . corrected lower end position, HS . . . corrected left end position, HU . . . corrected right end position, KJ... converted upper end position, KK... converted lower end position, KS... converted left end position, KU... converted right end position, L1... dotted line, L2... distance, P... driver, P1... viewpoint, P2-1... first risk index position, P2-2... second risk index position, P2... risk index position, R1... risk index range, S1... step (detection step), S6, S9, S12... step (display step), SG... captured image, VG... visibility-reducing image.

1. A vehicle display device, comprising:
a detection unit that detects a risk index that is present in front of a vehicle and has a possibility of coming into contact with the vehicle; and
a display control unit that displays an image on a windshield of the vehicle, wherein
the display control unit
momentarily displays a visibility-reducing image on the windshield in a range other than a risk index range corresponding to the risk index detected by the detection unit, the visibility-reducing image reducing visibility for a driver of the vehicle.

2. The vehicle display device according to claim 1,
further comprising a determination unit that determines whether the visibility-reducing image can be displayed,
wherein the determination unit determines whether the visibility-reducing image can be displayed based on at least one of the following: information about a road on which the vehicle is running, a period of time until contact with the risk index, a distance from a viewpoint of the driver on the windshield to the risk index, a state of the driver, and presence or absence of a driving assistance function of the vehicle.

3. The vehicle display device according to claim 2, wherein
the display control unit
displays the visibility-reducing image for a first period of time when the determination unit determines that the visibility-reducing image can be displayed, and
displays the visibility-reducing image for a second period of time longer than the first period of time when a gaze of the driver is not directed toward the risk index after the visibility-reducing image is displayed for the first period of time.

4. The vehicle display device according to claim 3, wherein
the visibility-reducing image displayed in the second period of time is an image that reduces visibility for the driver more than the visibility-reducing image displayed in the first period of time.

5. The vehicle display device according to claim 2, wherein
when the determination unit determines that the visibility-reducing image cannot be displayed, and
when the vehicle has an autonomous driving function,
the display control unit enables the autonomous driving function and displays the visibility-reducing image.

6. The vehicle display device according to claim 2, wherein
the vehicle display device is connected to a stimulus output device for outputting a stimulus other than a display to the driver and
includes a stimulus control unit for controlling the stimulus output device, and
when the determination unit determines that the visibility-reducing image cannot be displayed and
when the vehicle does not have an autonomous driving function,
the display control unit does not display the visibility-reducing image and the stimulus control unit causes the stimulus output device to output the stimulus.

7. The vehicle display device according to claim 1, wherein
the risk index range is a range based on a position and a size of the risk index and a position of the eyes of the driver in the vehicle.

8. The vehicle display device according to claim 7, wherein
the risk index range is a range based on information about a road on which the vehicle is running.

9. The vehicle display device according to claim 8, wherein
when the risk index includes a person and an object other than a person,
the display control unit displays the visibility-reducing image so that the person or the object is included in the risk index range based on information about a road on which the vehicle is running.

10. The vehicle display device according to claim 1,
wherein when a time until the vehicle comes in contact with the risk index is equal to or shorter than a predetermined value,
the display control unit displays the risk index range in an emphasized manner.

11. A method for controlling the vehicle display device, comprising:
a detection step of detecting a risk index that is present in front of a vehicle and has a possibility of coming into contact with the vehicle; and
a display step of displaying an image on a windshield of the vehicle, wherein
the display step
momentarily displays a visibility-reducing image on the windshield in a range other than a risk index range corresponding to the risk index detected in the detection step, the visibility-reducing image reducing visibility for a driver of the vehicle.

12. A non-transitory computer readable recording medium recording a program comprising causing
a processor to function as:
a detection unit that detects a risk index that is present in front of a vehicle and has a possibility of coming into contact with the vehicle; and
a display control unit that displays an image on a windshield of the vehicle, wherein
the display control unit
momentarily displays a visibility-reducing image on the windshield in a range other than a risk index range corresponding to the risk index detected by the detection unit, the visibility-reducing image reducing visibility for a driver of the vehicle.
